(19) United States
(12) Patent Application Publication
(10) Pub. No.: US 2015/0223005 A1
(43) Pub. Date: Aug. 6, 2015

(54) 3-DIMENSIONAL AUDIO PROJECTION

(71) Applicant: RAYTHEON COMPANY, WALTHAM, MA (US)

(72) Inventors: Brian T. Hardman, Greenwood, IN (US); Scott Sobczak, Fisher, IN (US); John M. Garro, Indianapolis, IN (US); Kevin R. Weber, Greenwood, IN (US)

(73) Assignee: RAYTHEON COMPANY, WALTHAM, MA (US)

(21) Appl. No.: 14/248,083

(22) Filed: Apr. 8, 2014

Related U.S. Application Data
(60) Provisional application No. 61/934,160, filed on Jan. 31, 2014.

(51) Int. Cl. H04S 7/00

(52) U.S. Cl. CPC H04S 7/302

(57) ABSTRACT

Described are computer-based methods and systems, including non-transitory computer program products, for audio data processing. In some examples, a 3-dimensional audio projection method includes receiving a signal including audio data and perceived location data. The perceived location data corresponds to a desired location from which sound associated with the audio data is to be perceived by a user in a 3-dimensional virtual environment. In addition, the method includes receiving a location and orientation of the user in physical space; determining a physical location in the physical space in which the user is to perceive the sound based on the perceived location data and the location and orientation of the user in physical space; and projecting the sound to the user in a 3-dimensional format based on the physical location in the physical space.

### BACKGROUND

Generally, when audio is transmitted (e.g., radio, telephone, voice over internet protocol, etc.), the audio loses spatial 3-dimensional quality and the audio is expressed as a directionless 2-dimensional sound to the listener. In some situations, the reconstruction and restoration of the missing third dimension of the transmitted sound to 3-dimensional sound is desirable to the listener. After reconstruction and restoration, the listener would then know from which direction the transmitted sound originated, such as air-to-air, air-to-ground, or ground-to-ground telecommunications where the listener desires to know the direction of a source of the audio relative to the listener in the auditory spectrum. Thus, a need exists in the art for improved 3-dimensional audio projection.

### SUMMARY

One approach is a system that projects 3-dimensional audio. The system includes a memory and one or more processors in communication with the memory. The one or more processors are configured to: receive a signal including audio data and perceived location data, the perceived location data corresponding to a desired location from which sound associated with the audio data is to be perceived by a user in a 3-dimensional virtual environment; receive a location and orientation of the user in physical space; determine a physical location in the physical space in which the user is to perceive the sound based on the perceived location data and the location and orientation of the user in physical space; and project the sound to the user in a 3-dimensional format based on the physical location in the physical space.

Another approach is a method for projecting 3-dimensional audio. The method includes, receiving, by one or more processors, a signal including audio data and perceived location data, the perceived location data corresponding to a desired location from which sound associated with the audio data is to be perceived by a user in a 3-dimensional virtual environment; receiving, by the one or more processors, a location and orientation of the user in physical space; determining, by the one or more processors, a physical location in the physical space in which the user is to perceive the sound based on the perceived location data and the location and orientation of the user in physical space; and projecting the sound to the user in a 3-dimensional format based on the physical location in the physical space.

One approach is a non-transitory computer readable medium storing computer readable instructions that, when executed by a processor, cause the processor to project 3-dimensional audio. The instructions further cause the processor to: receive a signal including audio data and perceived location data, the perceived location data corresponding to a desired location from which sound associated with the audio data is to be perceived by a user in a 3-dimensional virtual environment; receive a location and orientation of the user in physical space; determine a physical location in the physical space in which the user is to perceive the sound based on the perceived location data and the location and orientation of the user in physical space; and project the sound to the user in a 3-dimensional format based on the physical location in the physical space.

In other examples, any of the approaches above can include one or more of the following features.

In some examples, the method further includes: determining, by the one or more processors, the location of the user in the physical space based on data received from a positioning device; and determining, by the one or more processors, the orientation of the user based on a line of sight of the user.

In some examples, the 3-dimensional virtual environment is based on a scene presented to the user on a display device.

In other examples, the method further includes: determining, by the one or more processors, a virtual location and virtual orientation of the user in the 3-dimensional virtual environment; and mapping, by the one or more processors, the virtual location and virtual orientation of the user to the physical location.

In another embodiment, the method includes: identifying an avatar in the 3-dimensional virtual environment, wherein the avatar is a representation of the user in the 3-dimensional environment; and determining the virtual location and virtual orientation on the avatar in the 3-dimensional environment.

The 3-dimensional audio projection techniques described herein can provide one or more of the following advantages. An advantage of the technology is multiple users (transmitters) can communicate 3-dimensional audio to a single user (receiver), thereby enabling the single user to determine the approximate spatial relationship of the multiple users from the single user's location (e.g., transmitter is to the receiver's left, transmitter is to the receiver's right, etc.). Another advantage of the technology is the location data is embedded within the audio transmission, thereby reducing processing time for 3-dimensional audio projection by removing the need to correlate the location data and the audio data. Another advantage of the technology is that the projection of the 3-dimensional audio can occur in real-time with the transmission of the audio data due to the location data being embedded in the audio transmission, thereby enabling the technology to be utilized in real-time situations (e.g., emergency situation, fast-moving vehicles, etc.).

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an exemplary environment in which a 3-dimensional audio system is utilized, in accordance with an example embodiment of the present disclosure.

FIG. 2 is a diagram of exemplary virtual environment for which the 3-dimensional audio system of FIG. 1 is to project 3-dimensional audio.

FIG. 3 is a block diagram of an exemplary 3-dimensional audio system.

FIG. 4 is a schematic diagram of a user interface of another exemplary 3-dimensional audio system.

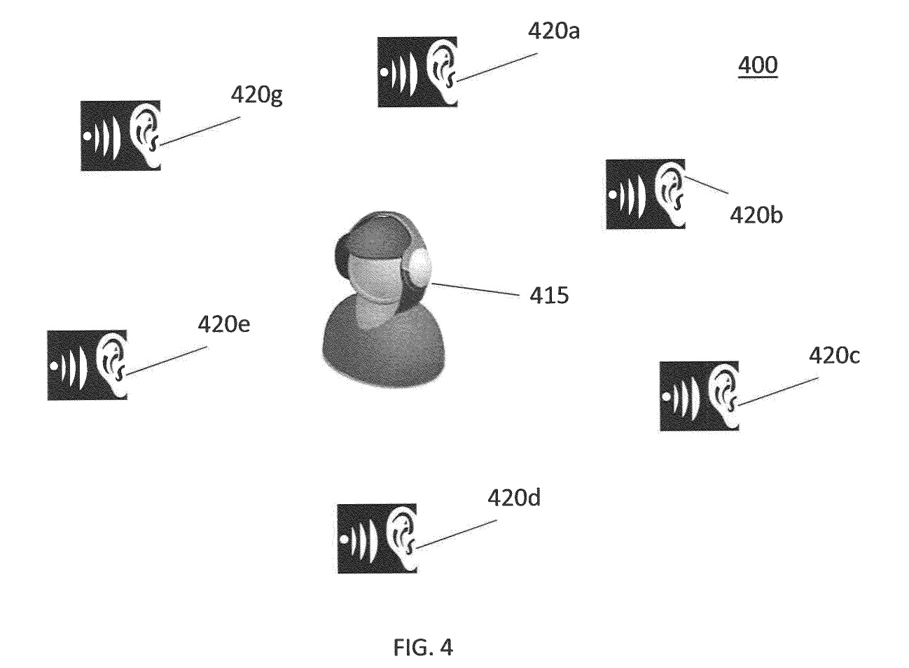

FIG. 5 is a flowchart of an exemplary 3-dimensional audio projection method.

### DETAILED DESCRIPTION

As technology becomes more advanced, entertainment systems increasingly immerse users in a virtual environment by utilizing advanced visual and audio tools. For example, high definition televisions (HDTVs) display images with high resolution. Such high-resolution images provide the user with a close to life-like viewing experience. For instance, sporting fans often comment that their particular HDTVs make them feel as if they are watching a sporting event at the stadium from which the event is being broadcast. In addition, entertainment systems can also include surround sound stereo equipment. The goal of surround sound stereo equipment is to simulate a 360-degree audio environment that simulates a real-life environment. However, such surround sound equipment generally requires the use of greater than two speakers and multiple audio channels. Thus, users wearing, for example, ear buds or a headset cannot experience a 3-dimensional environment.

Embodiments of the present disclosure produce a 3-dimensional audio environment for users wearing, for example, ear buds or a head set.

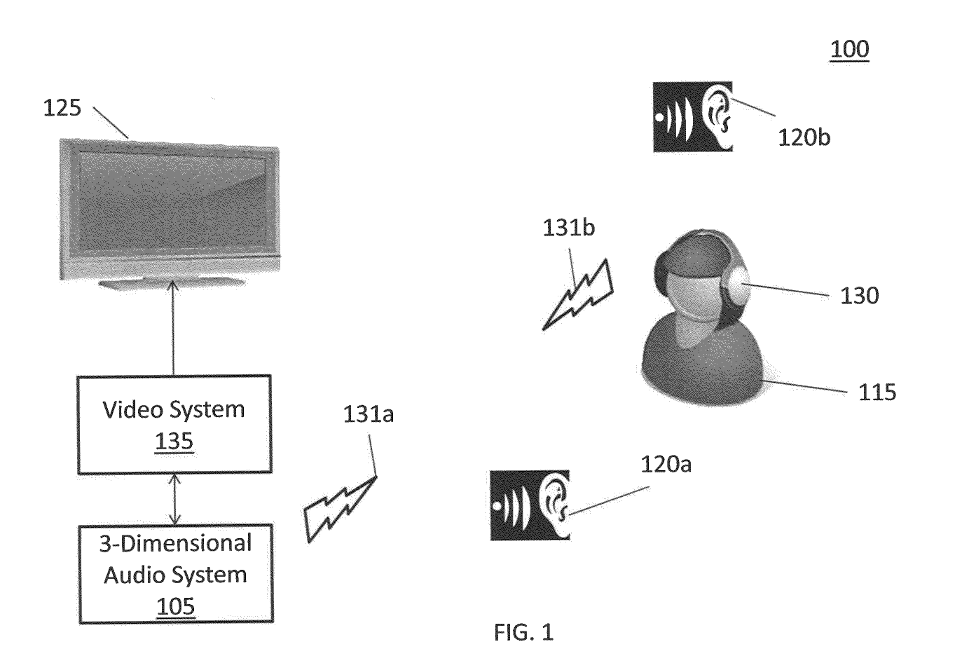

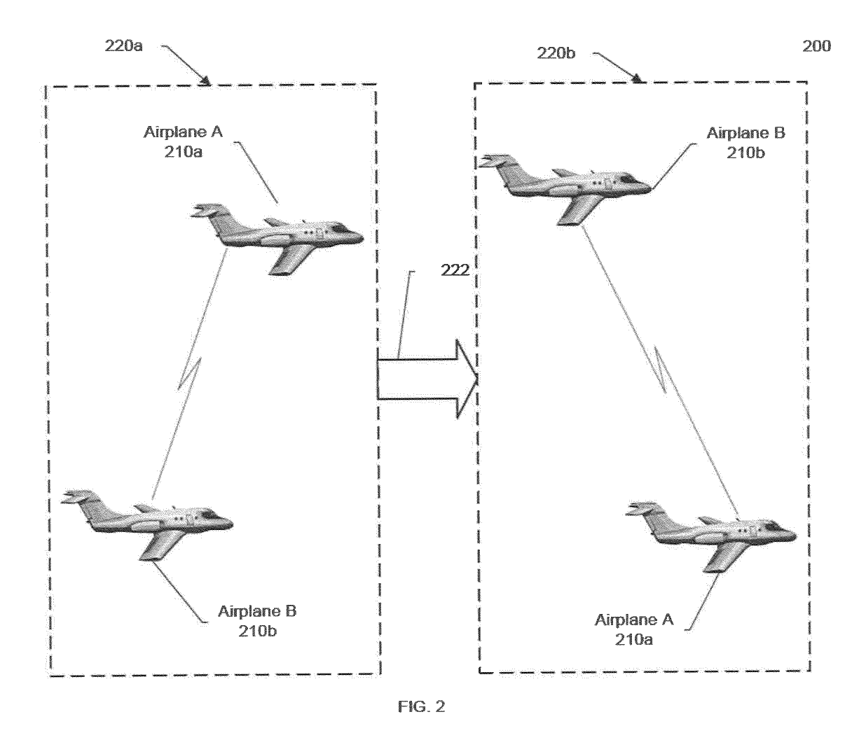

FIG. 1 is a diagram of an exemplary environment 100 in which a 3-dimensional audio system 105 is utilized. The exemplary environment 100 includes a display device 125, video system 135, 3-dimensional audio system 105, and a user 115 wearing a headset 130. The display device 125 can be, for example, a television or any other device that can be used to display an image. The display device 125 receives image data from video system 135. For example, the display device 125 can receive image data from a movie file to present to the user 115. In addition, the 3-dimensional audio system 105 receives audio data that corresponds to the image data received by the display device 125. The audio data includes perceived location information. The perceived location information corresponds to a desired location from which sound associated with the audio data is to be perceived by the user 115 in a 3-dimensional virtual environment. The 3-dimensional virtual environment can be an environment being presented to the user 115 on the display device 125. For example, the 3-dimensional virtual environment can be a gaming environment such as described in FIG. 2.

The 3-dimensional audio system 105 also receives information related to a location and orientation of the user 115 in the physical space of environment 100. The information can be received by the 3-dimensional audio system 105 via a wireless link 131b from the headset 130. The headset 130 can include an inertial head tracker (not shown) that obtains azimuth and elevation information of the head of the user 115 and a position of the user 115 in physical space. The information obtained by the inertial head tracker can be obtained using any method known or yet to be known in the art. The 3-dimensional audio system 105 receives the aforementioned information from the headset 130 and calculates a line of sight vector of the user 105.

The 3-dimensional audio system 105 utilizes the perceived location information and the position and line of sight information of the user 115 to determine a physical location in the physical space of environment 100 in which the user 115 is to perceive the sound associated with the audio data. For example, the user 115 can be playing a video game in which an object such a plane is positioned behind an avatar (a digital representation of the user 115) of the user 115 in the 3-dimensional virtual environment. In this example, the position corresponds to position 120b in the physical environment. As such, the 3-dimensional audio system 105 selects a head related transfer function (HRTF) from an HRTF table. The selected HRTF modifies the audio data to synthesize a binaural sound that seems to come from a particular point in space (i.e., position 120b). The system 105 sends the modified audio for output by headset 130 via wireless communication link 131a. It should be noted that although communication links 131a-b are illustrated as wireless links, a wired link can also be used.

The plane can move in the 3-dimensional environment such that any sound (e.g., engine noise and communication from a pilot of the plane) should seem to originate from position 120a based on received azimuth and elevation information of the user 115 at a specific point in time in which the system is to play sound to the user 115.

FIG. 2 is a diagram of an exemplary 3-dimensional virtual environment 200 for which the 3-dimensional audio system 105 of FIG. 1 is to project 3-dimensional audio. The environment 200 includes airplanes A 210a and B 210b at two different times 220a and 220b (e.g., 03:45.23 and 03:45.53, 04:33 and 04:45, etc). In this example, a pilot of airplane B 210b is an avatar of the user 115 of FIG. 1. As illustrated in FIG. 2, the airplanes A 210a and B 210b change positions (222) between the times 220a and 220b. At time 220a, for example, a voice communication from the airplane A 210a to the airplane B 210b is projected such that the user 115 perceives the communication as being received in an upper, front area of a virtual a cockpit of the airplane B 210b. At time 220b, for example, a voice communication from the airplane A 210a to the airplane B 210b is projected to the user such that the user perceived to communication to be received from an upper, rear area of the virtual cockpit of the airplane B 210b.

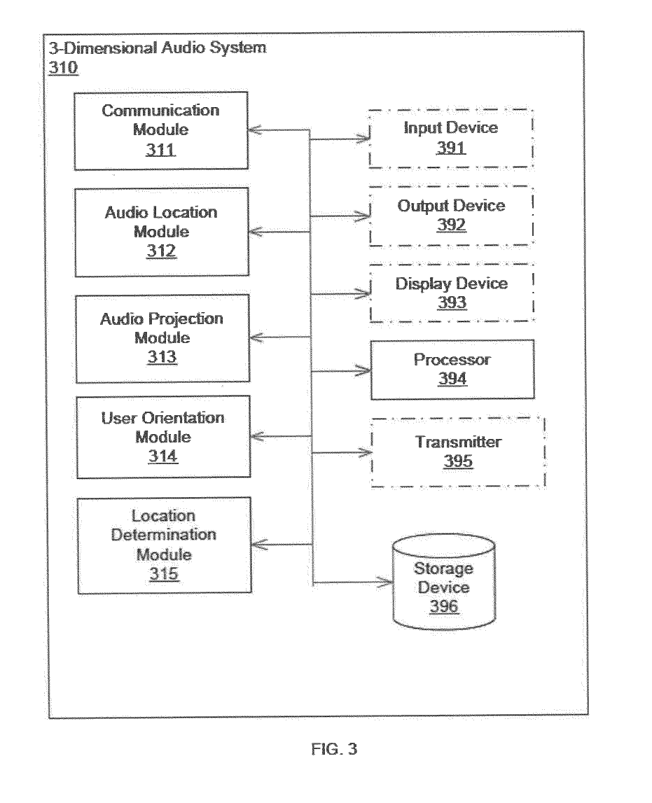

FIG. 3 is a diagram of a 3-dimensional audio system 310. The 3-dimensional audio system 310 includes a communication module 311, an audio location module 312, an audio projection module 313, a user orientation module 314, a location determination module 315, an input device 391, an output device 392, a display device 393, a processor 394, a transmitter 395, and a storage device 396. The input device 391, the output device 392, the display device 393, and the transmitter 395 are optional devices/components. The modules and devices described herein can, for example, utilize the processor 394 to execute computer executable instructions and/or include a processor to execute computer executable instructions (e.g., an encryption processing unit, a field programmable gate array processing unit, etc.). The modules can also be application specific instruction set processors (ASIP). It should be understood that the 3-dimensional audio system 310 can include, for example, other modules, devices, and/or processors known in the art and/or varieties of the illustrated modules, devices, and/or processors.

The communication module 311 communicates information to/from 3-dimensional audio system 310. The communication module 311 receives a plurality of audio transmissions. Each of the plurality of audio transmissions includes audio data and location data and the location data is associated with a perceived location from which sound associated with the audio data is to be perceived by the user.

The audio location module 312 determines, for the sound associated with the audio data, a relative location of the perceived location of the sound with respect to a user (e.g., user 115 of FIG. 1). The relative location is determined based on a location of the user and the perceived location data (e.g., source of an object in a 3-dimensional environment (e.g., the environment 200 of FIG. 2)). The audio projection module 313 3-dimensionally projects the sound associated with the audio data to the user based on the relative location (e.g., position 120a of FIG. 1). In some examples, the audio projection module 313 3-dimensionally projects, for each of the plurality of audio transmissions, the audio data to a user based on the relative location and the user orientation.

The user orientation module 314 determines a user orientation with respect to a source of the sound in the 3-dimensional virtual environment. The location determination module 315 determines the location of the source of the sound in the 3-dimensional virtual environment.

The input device 391 receives information associated with the 3-dimensional audio system 310 (e.g., instructions from a user, instructions from another computing device, etc.) from a user (not shown) and/or another computing system (not shown). The input device 391 can include, for example, a keyboard, a scanner, etc. The output device 392 outputs information associated with the 3-dimensional audio system 310 (e.g., information to a printer (not shown), information to a speaker, etc.).

The display device 393 displays information associated with the 3-dimensional audio system 310 (e.g., status information, configuration information, etc.). The processor 394 executes the operating system and/or any other computer executable instructions for the 3-dimensional audio system 310 (e.g., executes applications, etc.).

The storage device 396 stores position information and/or relay device information. The storage device 396 can store information and/or any other data associated with the 3-dimensional audio system 310. The storage device 396 can include a plurality of storage devices and/or the 3-dimensional audio system 310 can include a plurality of storage devices (e.g., a position storage device, a satellite position device, etc.). The transmitter 395 can send and/or receive transmission from and/or to the 3-dimensional audio system 310. The storage device 396 can include, for example, long-term storage (e.g., a hard drive, a tape storage device, flash memory, etc.), short-term storage (e.g., a random access memory, a graphics memory, etc.), and/or any other type of computer readable storage.

As stated herein, disclosed embodiment of the 3-dimensional audio projection systems and methods projects sound to a user such that the user perceives the sound as emanating from a particular point in space. The point in space is generally based on a location of the source of the sound in a 3-dimensional environment. However, there may be situations where a user (e.g., the user 115 of FIG. 1) wished to change the location in which the user 115 perceives the sound emanating. For example, the user may select an object in the 3-dimensional virtual environment and change the location in which the user perceives a sound (e.g., a communication) emanating from the object. The user can select any one of points 420a-g. In response to selecting, for example, point 420c, the user perceives sound coming from the user's left side.

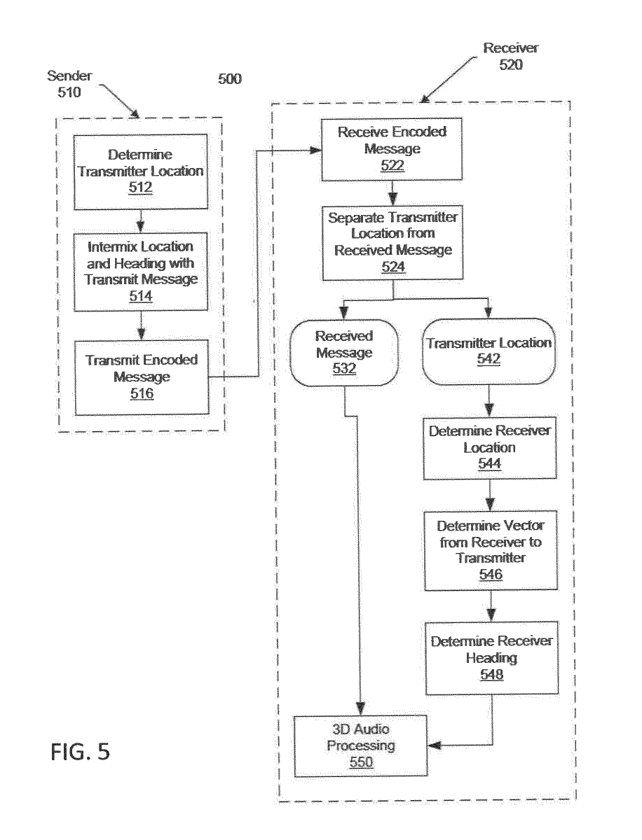

FIG. 5 is a flowchart 500 of an exemplary 3-dimensional audio projection method utilizing, for example, the environment 100 of FIG. 1. The processing of the flowchart 500 is divided between sender 510 and receiver 520 processing. In the sender 510 processing, the 3-dimensional audio system 105 determines (512) location data for an object in a 3-dimensional virtual environment from which sound is to emanate. The 3-dimensional audio system 105 intermixes (514) the location data and a message for transmission (e.g., audio message, a video message, etc.) to form an encoded message (also referred to as a voice transmission). The 3-dimensional audio system 105 transmits (516) the encoded message to the headset (e.g., the headset 130 of FIG. 1) of the user (the receiver in this example).

In the receiver 520 processing, a processor (not shown) receives (522) the encoded message. The headset separates (524) the location data (542) and the received message (532). The headset determines (544) the user's location. In addition, the headset determines (546) a vector from an avatar of the receiver to the object based on the receiver's location and the object's location data (542) in the 3-dimensional virtual environment. The headset determines (548) the receiver's heading. The headset processes (550) the received message (532), the vector, and the receiver's heading to project the audio from the received message (532) into a 3-dimensional space.

The above-described systems and methods can be implemented in digital electronic circuitry, in computer hardware, firmware, and/or software. The implementation can be as a computer program product a computer program tangibly embodied in an information carrier). The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by special purpose logic circuitry and/or an apparatus can be implemented on special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from, and/or can transfer data to one or more mass storage devices for storing data (e.g., magnetic, magneto-optical disks, optical disks, etc.).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The computing device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for 3-dimensional audio projection, the method comprising:
receiving, by one or more processors, a signal including audio data and perceived location data, the perceived location data corresponding to a desired location from which sound associated with the audio data is to be perceived by a user in a 3-dimensional virtual environment;
receiving, by the one or more processors, a location and orientation of the user in physical space;
determining, by the one or more processors, a physical location in the physical space in which the user is to perceive the sound based on the perceived location data and the location and orientation of the user in physical space; and
projecting the sound to the user in a 3-dimensional format based on the physical location in the physical space.

2. The method of claim 1 further comprising:
determining, by the one or more processors, the location of the user in the physical space based on data received from a positioning device; and
determining, by the one or more processors, the orientation of the user based on a line of sight of the user.

3. The method of claim 1 wherein the 3-dimensional virtual environment is based on a scene presented to the user on a display device.

4. The method of claim 1 wherein determining, by the one or more processors, a physical location in the physical space in which the user is to perceive the sound further includes:
determining, by the one or more processors, a virtual location and virtual orientation of the user in the 3-dimensional virtual environment; and
mapping, by the one or more processors, the virtual location and virtual orientation of the user to the physical location.

5. The method of claim 4 wherein determining the virtual location and virtual orientation of the user in the 3-dimensional virtual environment includes:
identifying an avatar in the 3-dimensional virtual environment, wherein the avatar is a representation of the user in the 3-dimensional environment; and
determining the virtual location and virtual orientation on the avatar in the 3-dimensional environment.

6. A system for 3-dimensional audio projection, the system comprising:
a memory; and
one or more processors in communication with the memory, the one or more processors configured to:
receive a signal including audio data and perceived location data, the perceived location data corresponding to a desired location from which sound associated with the audio data is to be perceived by a user in a 3-dimensional virtual environment;
receive a location and orientation of the user in physical space;
determine a physical location in the physical space in which the user is to perceive the sound based on the perceived location data and the location and orientation of the user in physical space; and
project the sound to the user in a 3-dimensional format based on the physical location in the physical space.

7. The system of claim 6 wherein the one or more processors are further configured to:
determine the location of the user in the physical space based on data received from a positioning device; and
determine the orientation of the user based on a line of sight of the user based on data received from the positioning device.

8. The system of claim 6 wherein the 3-dimensional virtual environment is based on a scene presented to the user on a display device.

9. The system of claim 6 further wherein the one or more processors are further configured to:
determine a virtual location and virtual orientation of the user in the 3-dimensional virtual environment; and
map the virtual location and virtual orientation of the user to the physical location.

10. The system of claim 9 wherein the one or more processors are further configured to:
identify an avatar in the 3-dimensional virtual environment, wherein the avatar is a representation of the user in the 3-dimensional environment; and
determine the virtual location and virtual orientation of the avatar in the 3-dimensional environment.
